(19) United States
(12) Patent Application Publication
(10) Pub. No.: US 2007/0233961 A1
(43) Pub. Date: Oct. 4, 2007

(54) Multi-portioned instruction memory

(76) Inventors: John P. Banning, Sunnyvale, CA (US); Guillermo J. Rozas, Los Gatos, CA (US)

Correspondence Address: WAGNER, MURABITO & HAO LLP, Third Floor, Two North Market Street, San Jose, CA, 95113, US

(21) Appl. No.: 11/395,627

(22) Filed: Mar. 31, 2006

(51) Int. Cl. G06F 12/00

(52) U.S. Cl. 711/125

(57) ABSTRACT

An instruction memory for storing a plurality of instruction bits. A first portion of the instruction memory is for storing a first subset of bits of the plurality of instruction bits. A second portion of the instruction memory is for storing a second subset of bits of the plurality of instruction bits, wherein the second subset of bits is operable to be accessed by an instruction extractor during an instruction extraction earlier than the first subset of bits.

### FIELD OF INVENTION

The present invention generally relates to the field of microprocessors. Specifically, embodiments of the present invention relate to a multi-portioned instruction memory.

### BACKGROUND OF THE INVENTION

Instruction cache size effects performance of a microprocessor. For instance, larger instruction caches decrease miss rates, improving performance. However, larger instruction caches also increase access time, which in turn either increases cycle time or increases the number of cycles to access the instruction cache, both of which lower performance.

### SUMMARY OF THE INVENTION

Accordingly, a need exists for increasing the size of an instruction cache without decreasing performance.

Various embodiments of the present invention provide an instruction memory for storing a plurality of instruction bits and a method for caching data in an instruction cache. In one embodiment, a first portion of the instruction memory is for storing a first subset of bits of the plurality of instruction bits. A second portion of the instruction memory is for storing a second subset of bits of the plurality of instruction bits, wherein the second subset of bits is operable to be accessed by an instruction extractor during an instruction extraction earlier than the first subset of bits.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram showing components of a microprocessor including a multi-portioned instruction cache, in accordance with an embodiment of the present invention.

FIG. 2 is a diagram of an exemplary Very Long Instruction Word (VLIW)-style packet, in accordance with one embodiment of the invention.

FIG. 3 is a diagram illustrating the caching of a subset of bits of a VLIW instruction fetch parcel in one portion of a multi-portioned instruction cache, in accordance with one embodiment of the invention.

FIG. 4 is a diagram of an exemplary Reduced Instruction Set Computer (RISC)-style packet, in accordance with one embodiment of the invention.

FIG. 5 is a diagram illustrating the caching of a subset of bits of a RISC instruction fetch parcel in one portion of a multi-portioned instruction cache, in accordance with one embodiment of the invention.

FIG. 6 is a flowchart diagram illustrating steps in a process for caching data in an instruction cache, in accordance with one embodiment of the present invention.

### DETAILED DESCRIPTION

Reference will now be made in detail to the various embodiments of the invention, examples of which are illustrated in the accompanying drawings. While the invention will be described in conjunction with the various embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Various embodiments of the present invention provide an instruction cache for caching a plurality of instruction bits and a method for caching data in an instruction cache. In one embodiment, a first portion of the instruction cache is for caching a first subset of bits of the plurality of instruction bits. A second portion of the instruction cache is for caching a second subset of bits of the plurality of instruction bits, wherein the second subset of bits is operable to be accessed by an instruction extractor during an instruction extraction earlier than the first subset of bits. While embodiments of the present invention are described with reference to an instruction cache, it should be appreciated that embodiments of the present invention also relate to a processor comprising an instruction memory.

Embodiments of the present invention provide for filling an instruction cache in a manner that allows for early access of bits used early in an instruction extraction operation. Previously, an instruction cache was filled with bits in the order the bits were received from memory. The present invention provides for swizzling fetched bits such that the bits used early in the extraction operation are located in one portion of the instruction cache while the remaining bits are located in another portion of the instruction cache. Swizzling refers to the action of reorganizing the instructions bits of the fetched bits when the instruction bits are received into the instruction cache. In one embodiment, the early extraction bits are cached in a portion of the instruction cache closest to the instruction extractor.

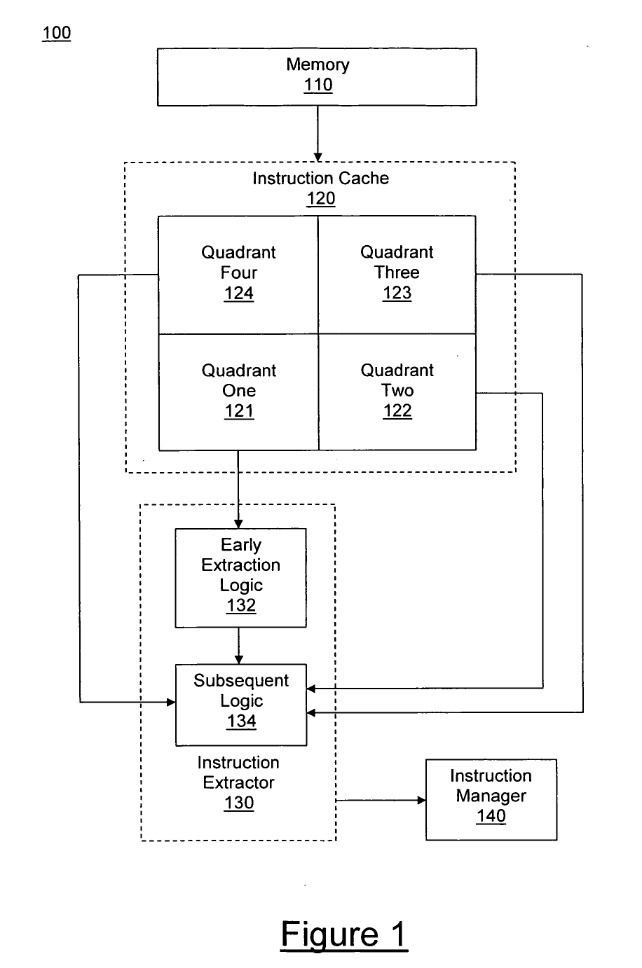

FIG. 1 is a block diagram showing front end components of a microprocessor 100 including a multi-portioned instruction cache 120, in accordance with an embodiment of the present invention. In one embodiment, microprocessor 100 comprises memory 110, instruction cache 120, instruction extractor 130, and instruction manager 140. It should be appreciated that microprocessor 100 may include additional components that are not shown so as to not unnecessarily obscure aspects of the embodiments of the present invention.

Memory 110 is operable to store instructions for use by microprocessor 100. Memory 110 stores the instructions as bits, also referred to herein as instruction bits. It should be appreciated that memory 110 may be volatile memory, also referred to as random access memory (RAM), or non-volatile memory, also referred to herein as read-only memory (ROM), for storing static information and instructions for a microprocessor.

In order to facilitate the instruction extraction, microprocessor 100 is operable to fetch a parcel of instruction bits from memory 110 for caching in instruction cache 120. In one embodiment, instruction cache 120 is a 256 KiB cache for caching 256 instruction bits. In one embodiment, instruction cache 120 includes four quadrants for caching instruction bits: quadrant one 121, quadrant two 122, quadrant three 123, and quadrant four 124. It should be appreciated that the operation of instruction cache 120 is described in greater detail below. Moreover, while embodiments of the present invention are described using quadrants of an instruction cache, it should be appreciated that other divisions of the instruction cache are possible, such as halves, octants, or non-equal portions.

Instruction extractor 130 is operable to extract instructions from the instruction bits cached in instruction cache 120. For instance, instruction extractor 130 is operable to access a plurality of instruction bits and to determine if a branch instruction is present, if a branch instruction is predicted taken, and to determine the branch instruction's destination address. In one embodiment, instruction extractor 130 is also operable to determine if a boundary exists in the instruction bits. In one embodiment, instruction extractor 130 is also operable to determine if there are enough bits to re-index instruction cache 120 again.

In one embodiment, instruction extractor 130 comprises early extraction logic 132 for performing early extraction operations on instruction bits cached in instruction cache 120, and subsequent logic 134 for performing subsequent extraction operations on instruction bits in instruction cache 120. In one embodiment, the early extraction operations comprise critical recurrence operations. In particular, the early extraction operations require only a subset of the instruction bits cached in instruction cache 120. The subsequent extraction operations require all instruction bits.

To a first approximation, the recurrence latency for the front end of microprocessor 100 includes instruction cache access time plus sufficient extraction of the fetched instructions to determine if a branch is present, if a branch is predicted taken, and to determine the branch's destination address, or if there are enough bits to index instruction cache 120 again. This early extraction need not be exact as it can be corrected later, and as long as the mis-decodes are sufficiently rare, performance is unaffected. Thus the instruction cache access time together with this partial approximate extraction and decision form the critical loop in the front end of microprocessor 100 and affects the branch taken penalty and the branch mis-predict penalty, both of which it is desirable to reduce.

In one embodiment, the partial approximate extraction and decision performed at early extraction logic 132 is inexpensive so that the main component of the critical loop is the instruction cache access time, and secondarily the determination of whether a (predicted taken) branch is present and the target destination. Part of the instruction cache access time is the time for the data delivered by the data arrays (e.g., instruction cache 120) to travel to the early extraction logic 132 (e.g., critical recurrence logic).

As described above, only a subset of the instruction bits are required by early extraction logic 132. As the size of the instruction cache 120 increases, the access time of this subset of bits potentially increases. In order to improve access time, and thus improve performance of microprocessor 100, the subset of bits required by early extraction logic 132 are cached in a specific portion of instruction cache 120. In other words, instruction cache 120 is operable to swizzle the bits of the fetch parcel such that the subset of bits required by early extraction logic 132 are cached in one portion of instruction cache 120, and the remaining bits are cached in another portion of instruction cache 120.

In one embodiment, the subset of instruction bits required for early extraction operations are cached in quadrant one 121 of instruction cache 120. In one embodiment, quadrant one 121 is in closer temporal proximity to instruction extractor 130, and thus early extraction logic 132, than quadrant two 122, quadrant three 123, and quadrant four 124.

It should be appreciated that other components of the front end of microprocessor 100 (e.g., subsequent pipe stages such as instruction manager 140) can decide on instruction boundaries, issue restrictions, etc. Furthermore, subsequent stages can correct any mis-decodes or mis-predictions by the critical loop in case the extraction is not exact, or a branch predictor disagrees with the static taken hint bit, as understood by those of skill in the art.

The described embodiments of the present invention provide for quick access of instruction cache 120 and quick (probabilistically correct but not necessarily deterministically correct) decode of branch instructions and prediction of target so that the instruction cache 120 fetch from memory 110 can be re-steered to the new target location.

It should also be appreciated that the described embodiments can be used with Reduced Instruction Set Computer (RISC) microprocessors, Very Long Instruction Word (VLIW) microprocessors, and microprocessors employing other encoding styles.

As described above, only a subset of bits of a parcel are required to perform this determination. For example, consider an exemplary instruction fetch parcel including eight thirty-two bit packets. In one embodiment, four of the packets include bits required in early extraction. In one embodiment, each of these four packets includes sixteen such bits. Therefore, only one-fourth of all the bits fetched are needed in the early extraction operation. The rest of the bits are needed in subsequent stages of the front end or back end, but do not affect early extraction operations, such as critical recurrence.

In one embodiment, instruction cache 120 is a 256 KiB Instruction cache. In one embodiment, instruction cache 120 can be viewed as four sixty-four KiB instruction caches accessed in parallel. As shown, instruction cache 120 includes quadrant one 121, quadrant two 122, quadrant three 123, and quadrant four 124.

On instruction cache fills (e.g., from an L2 or deeper cache, or from memory 110), the bits are swizzled so that the bits required in early extraction are in quadrant one 121 of instruction cache 120. In one embodiment, as shown, quadrant one 121 is nearest early extraction logic 132. The bits not required in early extraction are cached in the other three quadrants.

By collecting the bits used early in instruction extraction in the quadrant closest to early extraction logic 132, early extraction operations, such as critical recurrence, are affected only by the access time of a sixty-four KiB instruction cache, which is faster than the access time of 256 KiB instruction cache. Moreover, the capacity of instruction cache 120 is 256 KiB.

Therefore, in one embodiment, the critical recurrence timing only involves a sixty-four KiB quadrant (sub-array), and this quadrant can be placed optimally with respect to the recurrence decode logic (e.g., early extraction logic 132), reducing signal propagation delay.

It should be appreciated that the size of instruction cache 120, the number of portions for caching instruction bits, and the number of decoded branches of the describe embodiment are exemplary, and other sizes, portions and decoded branches may be used. Moreover, it should be appreciated that although the illustrations and description apply to direct branches, they can be extended to indirect branches as well.

Instruction extractor 130 is operable to transmit instructions to subsequent stages of microprocessor 100. In one embodiment, instruction extractor 130 transmits instruction to instruction manager 140. In one embodiment, these later stages can place the bits in the original order of the fetch parcel as supplied by memory 110. In other words, later stages of the pipeline can ‘unswizzle’ the bits as necessary so that subsequent stages of microprocessor 100 are unaware that the swizzling was ever performed.

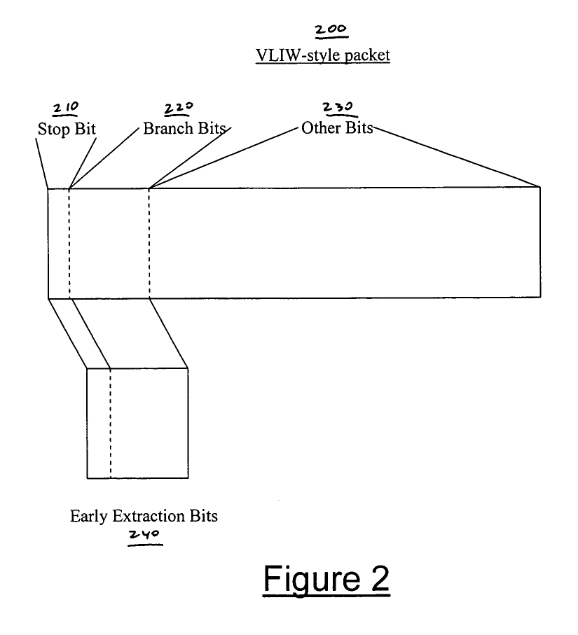

FIG. 2 is a diagram of an exemplary Very Long Instruction Word (VLIW)-style packet 200, in accordance with one embodiment of the invention. VLIW-style packet 200 includes thirty-two bits, including stop bit 210, branch bits 220, and other bits 230. Stop bit 210 is used to indicate whether VLIW-style packet 200 is the last packet of an instruction. Branch bits 220 include information used for determining if a branch is present, if a branch is predicted taken, and for determining the branch's destination address. It should be appreciated that information from other sources that is available at this time can be used in the prediction of conditional and indirect branches.

It should also be appreciated that there can be any number of branch bits 220, so long as the total number of branch bits in a fetch parcel is less than the total number of bits in the fetch parcel. In one embodiment, there are between two and seven branch bits. In another embodiment, where only every other packet of a VLIW fetch parcel includes branch bits, there are between two and fourteen branch bits. Other bits 230 are bits that are not required for performing early extraction operations, and are used in subsequent extraction.

VLIW packet early extraction bits 240 are those bits used in early extraction operations. In one embodiment, early extraction bits 240 includes stop bit 210 and branch bits 220. However, it should be appreciated that early extraction bits 240 can include only one stop bit 210 and branch bits 220. Moreover, it should be appreciated that early extraction bits can include other types of bits that are identified for use in early extraction operations.

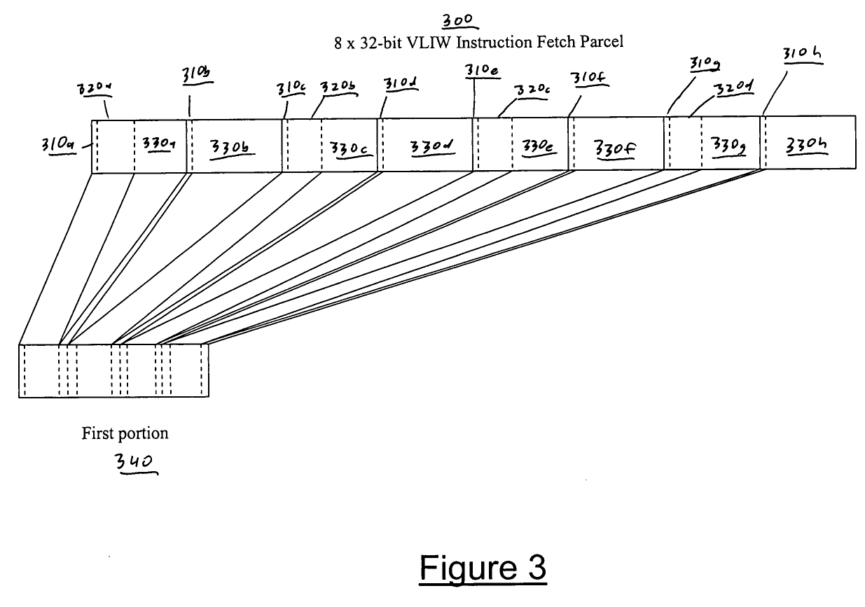

FIG. 3 is a diagram illustrating the caching of a subset of bits of an exemplary VLIW instruction fetch parcel 300 in one portion 340 of a multi-portioned instruction cache (e.g., instruction cache 120 of FIG. 1), in accordance with one embodiment of the invention. VLIW instruction fetch parcel 300 includes eight packets. For purposes of illustration with reference to FIG. 3, these packets are referred to as, from left to right, packets zero through packet seven. In one embodiment, the packets are thirty-two bit packets for a total of 256 bits in the fetch parcel. Each packet includes a stop bit 310a-h, respectively, and other bits 330a-h, respectively. In one embodiment, even numbered packets also include branch bits 320a-d, such that packets zero, two, four and six include branch bits 320a-d, respectively. It should be appreciated that any packet can include branch bits, and that the present invention is not limited to the present embodiment.

In the present embodiment, stop bits 310a-h and branch bits 320a-d are required to perform early extraction operations of an instruction extractor (e.g., instruction extractor 130 of FIG. 1). Stop bits 310a-h and branch bits 320a-d are cached in first portion 340 of an instruction cache. Other bits 330a-h are stored in a second portion (not shown) of the instruction cache.

In one embodiment, first portion 340 is quadrant one 121 of FIG. 1 and the second portion comprises quadrant two 122, quadrant three 123, and quadrant four 124 of FIG. 1. It should be appreciated that other bits 330a-h can be distributed across quadrant two 122, quadrant three 123, and quadrant four 124 in any manner. In the present embodiment, the total number of bits for use by the early extraction operation is no more than sixty-four bits, the size of each quadrant.

As described above, first portion 340 of the instruction cache is used for caching instruction bits that are used for performing early extraction operations of an instruction extraction operation. In one embodiment, first portion 340 is located in closer temporal proximity to the logic responsible for the instruction extraction than the second portion. In other words, the bits of VLIW instruction fetch parcel 300 are swizzled such that those bits used for performing early extraction operations are in first portion 340 and the remaining bits are cached in another portion of the instruction cache.

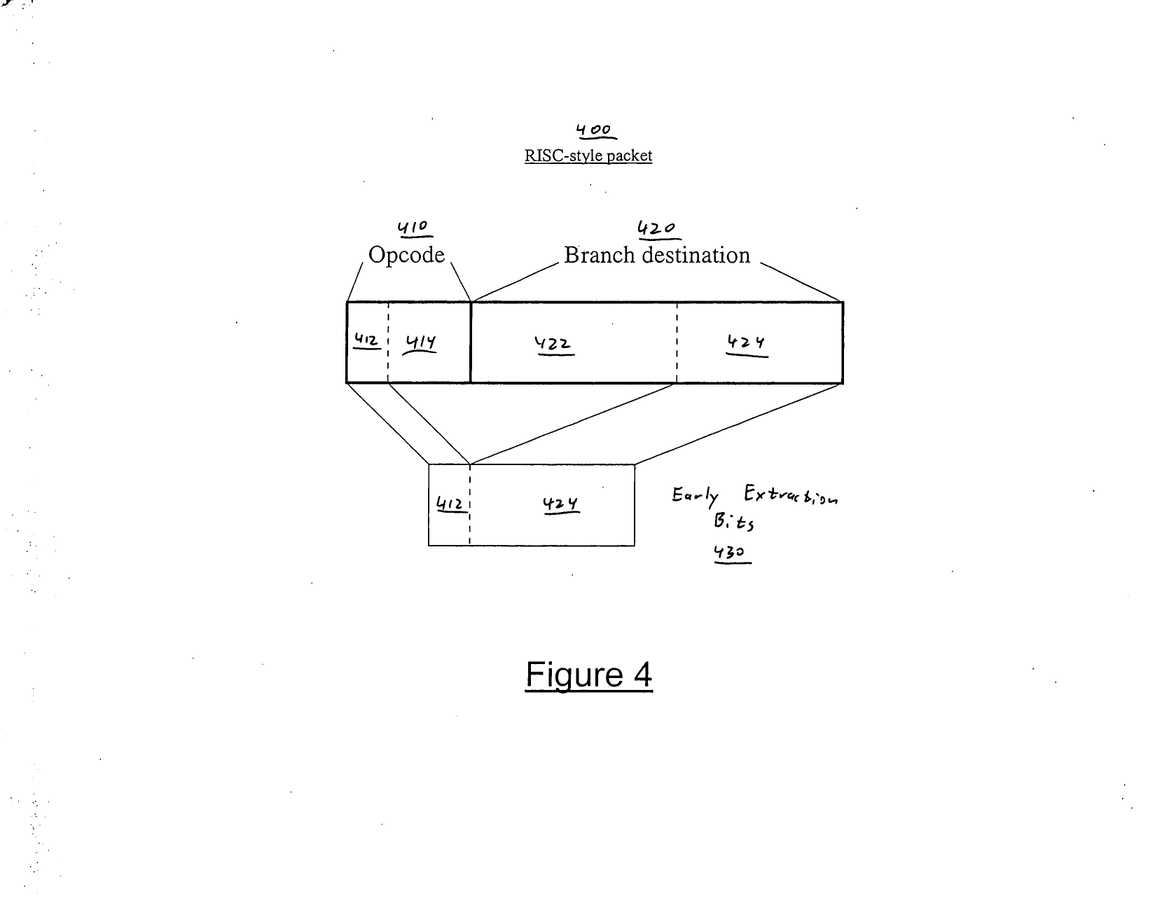

FIG. 4 is a diagram of an exemplary Reduced Instruction Set Computer (RISC)-style packet 400, in accordance with one embodiment of the invention. In one embodiment, RISC-style packet 400 includes 32 bits, including opcode bits 410 and branch bits 420. In one embodiment, opcode bits 410 include six bits of major opcode, two of which can correspond to ‘unconditional direct’ and ‘conditional direct’ branches. If the opcode bits 410 are chosen appropriately, and a static taken hint bit is provided as part of the opcode bits 410, both conditional direct predicted-taken and unconditional direct (always taken) branches can be predicted in the early extraction operation. It should be appreciated that other information than these bits can be involved in the prediction, so long as enough bits of the RISC-style packet 400 are used.

Furthermore the branch target address (or offset) can be encoded in (most) of the remaining bits of the branch instruction. It should be appreciated that only a subset of those target/offset bits are necessary early in an instruction extraction operation, as they are the ones used to compute the address used to index the instruction cache (tags and array). The rest of the bits participate in the tag comparison only, and as such are only necessary after the tag array has been accessed. In particular, the larger the associativity of the instruction cache, the fewer targevoffset bits that are needed to index the instruction cache.

Accordingly, only a subset of the bits of an instruction are necessary as part of the critical recurrence (e.g., an early extraction operation). These bits are shown in FIG. 3 as opcode bits 412 and branch bits 424. The rest of the bits of the instructions, opcode bits 414 and branch bits 422, can be provided later, and as such, can take longer to be accessed in the instruction cache. Opcode bits 412 and branch bits 424 are collectively referred to as early extraction bits 430.

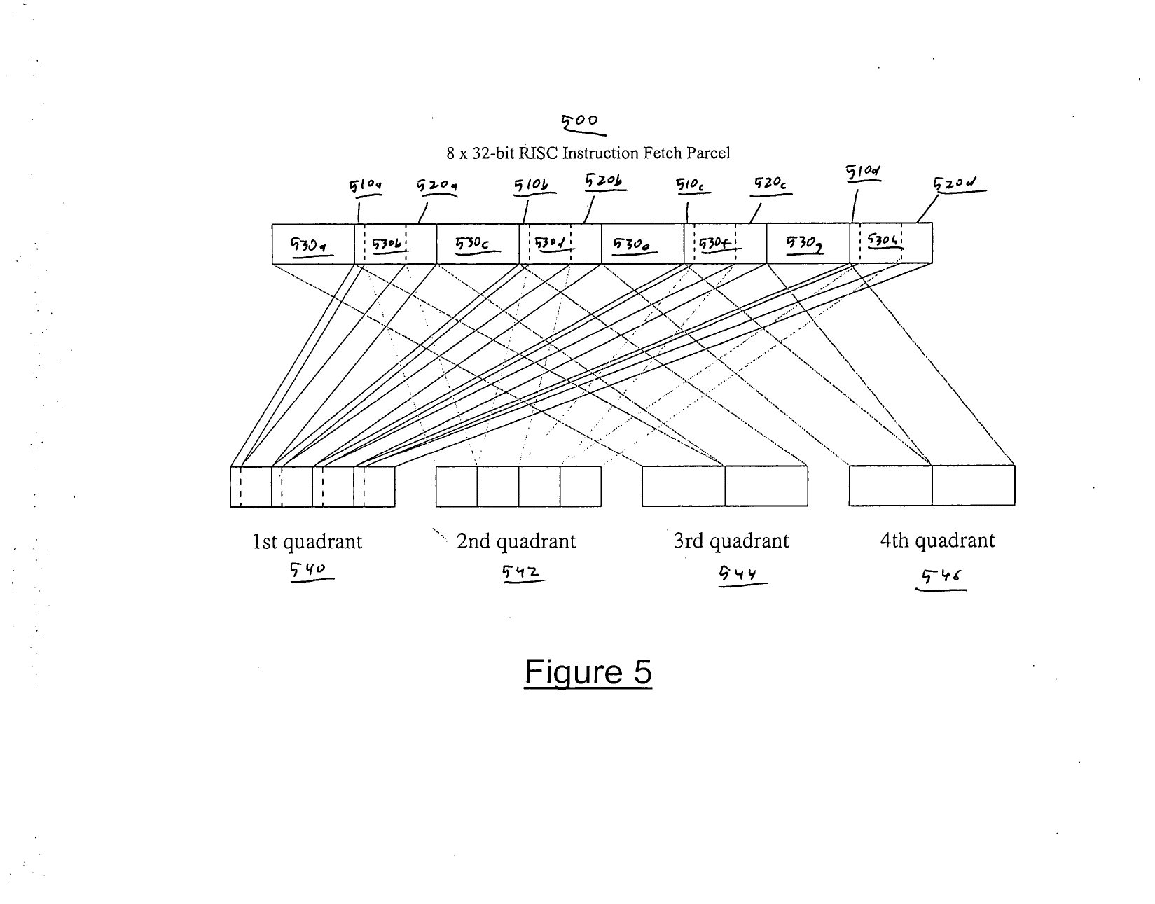

Further reduction of the number of bits required can be accomplished by restricting the number of locations in which a branch can be present. FIG. 5 is a diagram illustrating the caching of a subset of bits of a RISC instruction fetch parcel 500 in one portion of a multi-portioned instruction cache (e.g., instruction cache 120 of FIG. 1), in accordance with one embodiment of the invention. RISC instruction fetch parcel 500 includes eight packets. For purposes of illustration with reference to FIG. 3, these packets are referred to as, from left to right, packets zero through packet seven. In one embodiment, the packets are thirty-two bit packets for a total of 256 bits in the fetch parcel 500. In the present embodiment, the odd number packets include early extraction opcode bits 510a-d, respectively, and early extraction branch bits 520a-d, respectively, such that packets one, three, five and seven include early extraction opcode bits and early extraction branch bits. It should be appreciated that any packet can include early extraction opcode bits and early extraction branch bits, and that the present invention is not limited to the present embodiment.

For example, although arbitrary instructions can be at any address that is a multiple of four, branches could be restricted to appear at addresses that are always a multiple of eight, such that only half of the locations need to be examined for instruction bits used in early extraction operations.

Furthermore, in one embodiment, arbitrary alignment for branches is allowed, but mis-aligned branches will not be detected this early in the front end and will suffer a performance penalty. This leaves the user-visible architecture unchanged and potentially backwards compatible, while providing extra performance (by reducing the number of cycles of the recurrence) for properly-compiled and laid out code.

In the present embodiment, early extraction opcode bits 510a-d and early extraction branch bits 520a-d are required to perform early extraction operations of an instruction extractor (e.g., instruction extractor 130 of FIG. 1). Early extraction opcode bits 51 0a-d and early extraction branch bits 520a-d are cached in a first portion of an instruction cache. Other bits 530a-h are stored in a second portion (not shown) of the instruction cache. In one embodiment, the first portion is first quadrant 540 and the second portion includes second quadrant 542, third quadrant 544, and fourth quadrant 546. In one embodiment, the first portion is quadrant one 121 of FIG. 1 and the second portion comprises quadrant two 122, quadrant three 123, and quadrant four 124 of FIG. 1.

As shown, other bits 530b, 530d, 530f and 530h are allocated to second quadrant 542, other bits 530a and 530c are allocated to third quadrant 544, and other bits 530e and 530g are allocated to fourth quadrant 546. It should be appreciated that other bits 530a-h can be distributed across second quadrant 542, third quadrant 544, and fourth quadrant 546 in any manner, and is not limited to the described embodiment.

In the present embodiment, the total number of bits for use by the early extraction operation is no more than sixty-four bits, the size of each quadrant. As described above, first quadrant 540 of the instruction cache is used for caching instruction bits that are used for performing early extraction operations of an instruction extraction operation, such as critical recurrence operations. In one embodiment, first quadrant 540 is located in closer temporal proximity to the logic responsible for the instruction extraction than second quadrant 542, third quadrant 544, and fourth quadrant 546. In other words, the bits of RISC instruction fetch parcel 500 are swizzled such that those bits used for performing early extraction operations are cached in one portion of the instruction cache (e.g., first quadrant 540) and the remaining bits are cached in another portion (e.g., second quadrant 542, third quadrant 544, and fourth quadrant 546).

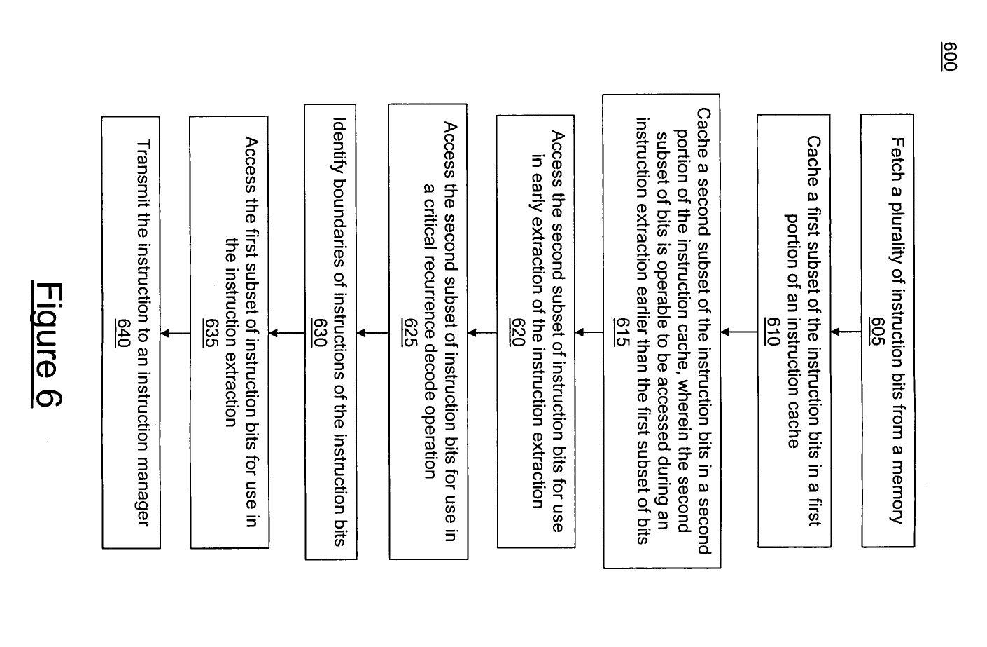

FIG. 6 is a flowchart diagram illustrating steps in a process 600 for caching data in an instruction cache, in accordance with one embodiment of the present invention. In one embodiment, process 600 is carried out by processors and electrical components under the control of computer readable and computer executable instructions. The computer readable and computer executable instructions reside, for example, in data storage features such as computer usable volatile and non-volatile memory. However, the computer readable and computer executable instructions may reside in any type of computer readable medium. Although specific steps are disclosed in process 600, such steps are exemplary. That is, the embodiments of the present invention are well suited to performing various other steps or variations of the steps recited in FIG. 6. In one embodiment, process 600 is performed by microprocessor 100 of FIG. 1.

At step 605 of process 600, a plurality of instruction bits are fetched from a memory (e.g., memory 110 of FIG. 1). The plurality of instruction bits are also referred to herein as a fetch parcel. In one embodiment, 256 instruction bits are fetched from the memory, wherein the instruction bits comprise eight packets of thirty-two bits. In one embodiment, the plurality of instruction bits comprises at least one RISC instruction. In one embodiment, the plurality of instruction bits comprises at least one VLIW instruction.

At step 610 a first subset of the instruction bits are cached in a first portion of an instruction cache (e.g., quadrant one 121 of instruction cache 120). At step 615, a second subset of the instruction bits is cached in a second portion of the instruction cache (e.g., quadrant two 122, quadrant three 123, and quadrant four 124 of instruction cache 120), wherein the second subset of bits is operable to be accessed during an instruction extraction earlier than the first subset of bits. In one embodiment, steps 610 and 615 occur simultaneously. For example, the instruction cache receives the instruction bits sequentially, and places an instruction bit in an appropriate portion of the instruction cache as the instruction bit is received.

In one embodiment, the second subset of bits comprises at least one stop bit indicating a boundary between instructions. In one embodiment, the second subset of bits comprises branch bits indicating a branch instruction.

At step 620, the second subset of instruction bits is accessed for use in an early extraction operation of the instruction extraction. In one embodiment, the early extraction operation comprises commencing a critical recurrence decode operation, as shown at step 625. The critical recurrence operation includes identifying present branches, predicting branches, and if predicted taken, changing the next fetch address. In particular, only the second subset of instruction bits is necessary for performing the critical recurrence operation.

It should be appreciated that some of the critical recurrence operation may require instruction bits of the first subset. For example, identifying present branches, predicting them, and changing the next fetch address can happen after step 625 when the rest of the instruction bits are available. In one embodiment, at step 625 the decoding and branch prediction is performed while the fetch address is assembled later, e.g., at step 635. The critical recurrence is still shorter because most of the computation can be started earlier, even though it is not completed until the instruction bits from the “first subset” are available.

In one embodiment, as shown at step 630, the early extraction operation identifies boundaries of instructions of the instruction bits. In particular, only the second subset of instruction bits is necessary for identifying the boundaries of instructions. It should be appreciated that step 630 is optional, and may be performed at a later stage of the pipeline.

At step 635, the first subset of instruction bits is accessed for use in subsequent operations of the instruction extraction. In one embodiment, the critical recurrence operation is completed using instruction bits of the first subset.

At step 640, the instruction is transmitted to an instruction manager (e.g., instruction manager 140 of FIG. 4).

As described above, while embodiments of the present invention are described with reference to an instruction cache, it should be appreciated that embodiments of the present invention also relate to a processor comprising an instruction memory. In particular, an instruction memory could operate in the same manner as an instruction cache as described herein, wherein instruction bits when accessed out of memory are loaded into the instruction memory such that one subset of the bits are stored in a separate portion of the instruction memory than another subset of the bits.

In summary, various embodiments of the present invention provide for efficient allocation of instruction bits in an instruction cache. By using a memory structure that gives some bits sooner than others and organizing the instructions in such a memory so that those bits that drive the longest part of the processing are available first, the present invention allows for faster processing of the accessed instructions by the memory structure. Moreover, by placing the early accessed instruction bits in a portion of the instruction cache temporally closer to the instruction extractor than the other instruction bits, the present invention further improves effective access time of the bits required early in an instruction extraction operation. Furthermore, the described invention allows for increasing the size of an instruction cache without decreasing the performance.

Various embodiments of the present invention, an instruction memory for storing a plurality of instruction bits and a method for storing data in an instruction memory, are thus described. While the present invention has been described in particular embodiments, it should be appreciated that the present invention should not be construed as limited by such embodiments, but rather construed according to the below claims.

What is claimed is:

1. An instruction memory for storing a plurality of instruction bits, said instruction memory comprising:
a first portion for storing a first subset of bits of said plurality of instruction bits; and
a second portion for storing a second subset of bits of said plurality of instruction bits, wherein said second subset of bits is operable to be accessed by an instruction extractor during an instruction extraction earlier than said first subset of bits.

2. The instruction memory of claim 1, wherein said instruction memory is an instruction cache.

3. The instruction memory of claim 1, wherein said second portion is in closer temporal proximity to said instruction extractor than said first portion.

4. The instruction memory of claim 1, wherein said instruction extractor comprises early extraction logic that is operable to access said second subset of bits.

5. The instruction memory of claim 1, wherein said instruction memory comprises four quadrants, wherein a first quadrant is in closer temporal proximity to said instruction module, such that said second subset of bits is stored within said first quadrant.

6. The instruction memory of claim 1, wherein said plurality of instruction bits comprises 256 bits.

7. The instruction memory of claim 1, wherein said second subset of bits comprises at least one stop bit indicating a boundary between instructions.

8. The instruction memory of claim 7, wherein said instruction extraction comprises discovering boundaries of instructions using said stop bit.

9. The instruction memory of claim 1, wherein said second subset of bits comprises branch bits indicating a branch instruction.

10. The instruction memory of claim 1, wherein said plurality of instruction bits comprises at least one Reduced Instruction Set Computer (RISC) instruction.

11. The instruction memory of claim 1, wherein said plurality of instruction bits comprises at least one Very Long Instruction Word (VLIW) instruction.

12. A microprocessor comprising:
a memory for storing instruction bits;
an instruction cache coupled to said memory for fetching and caching a plurality of said instruction bits, said instruction cache comprising:
a first portion for caching a first subset of bits of said plurality of instruction bits; and
a second portion for caching a second subset of bits of said plurality of instruction bits; and
an instruction extractor operable to access said second subset of bits during an instruction extraction earlier than said first subset of bits.

13. The microprocessor of claim 12 wherein said second portion is in closer temporal proximity to said instruction extractor than said first portion.

14. The microprocessor of claim 12, wherein said instruction extractor comprises early extraction logic that is operable to access said second subset of bits.

15. The microprocessor of claim 12, wherein said instruction cache comprises four quadrants, wherein a first quadrant is in closer temporal proximity to said instruction module, such that said second subset of bits is cached within said first quadrant.

16. The microprocessor of claim 12, wherein said second subset of bits comprises at least one stop bit indicating a boundary between instructions.

17. The microprocessor of claim 16, wherein said instruction extractor is operable to discover boundaries of instructions using said stop bit.

18. The microprocessor of claim 12, wherein said second subset of bits comprises branch bits indicating a branch instruction.

19. The microprocessor of claim 12, wherein said plurality of instruction bits comprises at least one Reduced Instruction Set Computer (RISC) instruction.

20. The microprocessor of claim 12, wherein said plurality of instruction bits comprises at least one Very Long-Instruction Word (VLIW) instruction.

21. A method for storing data in an instruction memory, said method comprising:
fetching a plurality of instruction bits from a memory;
storing a first subset of said instruction bits in a first portion of said instruction cache;
storing a second subset of said instruction bits in a second portion of said instruction cache, wherein said second subset of bits is operable to be accessed during an instruction extraction earlier than said first subset of bits.

22. The method as recited in claim 21, wherein said instruction memory is an instruction cache.

23. The method as recited in claim 21 further comprising:
accessing said second subset of instruction bits for use in early extraction of said instruction extraction; and
subsequently, accessing said first subset of instruction bits for use in said instruction extraction.

24. The method as recited in claim 21 further comprising:
identifying boundaries of instructions of said instruction bits, and
transmitting said instruction to an instruction manager.

25. The method of claim 21, wherein said second subset of bits comprises at least one stop bit indicating a boundary between instructions.

26. The method of claim 21, wherein said second subset of bits comprises branch bits indicating a branch instruction.

27. The method of claim 21, wherein said plurality of instruction bits comprises at least one Reduced Instruction Set Computer (RISC) instruction.

28. The method of claim 21, wherein said plurality of instruction bits comprises at least one Very Long Instruction Word (VLIW) instruction.
